(19) United States
(12) Patent Application Publication
(10) Pub. No.: US 2015/0059695 A1
(43) Pub. Date: Mar. 5, 2015

(54) Long Power Stroke Engine

(71) Applicant: Otto M. Wildensteiner, Hilton Head, SC (US)

(72) Inventor: Otto M. Wildensteiner, Hilton Head, SC (US)

(21) Appl. No.: 13/986,898

(22) Filed: Aug. 28, 2013

(51) Int. Cl. F02B 23/08; F01L 15/20

(52) U.S. Cl. CPC F02B 23/08; F01L 15/20
USPC 123/403; 123/90.6; 123/657

(57) ABSTRACT

Means and method of substantially increasing the efficiency of a spark ignition Otto cycle engine. This is done by increasing the stroke length of the pistons and reducing the amount of air (or fuel/air mixture) by means other than the throttle plate taken in on the intake stroke. The amount of air or fuel/air mixture taken in is that which creates the same conditions in the combustion chamber at the conclusion of the compression stroke as exist in prior art engines used for the same application. The advantage arises from the increase in the length of the power stroke; this extracts more energy from the combustion gases before they are removed on the exhaust stroke and it also increases the torque of the engine as it is well known that torque is a function of stroke length. Extracting more energy from the combustion gases also reduces the amount of heat transferred to the engine block, thereby reducing the load on the cooling system.

### CROSS-REFERENCE TO RELATED APPLICATIONS

This application claims the benefit of Provisional Patent Application Ser. No. 61/690,836 filed Jul. 6, 2012 titled Long Power Stroke Engine.

### STATEMENT REGARDING FEDERALLY SPONSORED RESEARCH OR DEVELOPMENT

There was no federal sponsorship in the development of the present invention.

### THE NAMES OF THE PARTIES TO A JOINT RESEARCH AGREEMENT

None.

### BACKGROUND

The present invention is in the field of Otto cycle 4 stroke spark ignition internal combustion engines.

### BRIEF SUMMARY OF THE INVENTION

Briefly, the present invention is a means and method of increasing the efficiency of a conventional 4 stroke spark ignition engine. This is done by increasing the length of the stroke of an engine by 50% to 100% and reducing the amount of air or fuel/air mixture that is taken into the cylinders by an amount such that at the end of the compression stroke the conditions in the combustion chamber are the same as those in the combustion chambers of prior art engines. Since the stroke length is greater than that of prior art engines the combustion gases remain in the cylinder for a longer time, thus extracting more energy from them. In addition, the longer stroke length results in greater torque being generated.

### BRIEF DESCRIPTION OF THE SEVERAL VIEWS OF THE DRAWING

FIG. 1 shows a comparison of the travel of a piston of a prior art engine with that of a piston of an engine of the present invention.

FIG. 2 shows an alternate means of achieving the improvement in efficiency of the present invention.

### DETAILED DESCRIPTION OF THE INVENTION

The amount of energy in the combustion gases that is wasted by prior art engines is considerable. All prior art engines, when operated at high RPMs, waste enough heat energy out of the exhaust valves to cause the exhaust pipes to glow bright orange. This is a result of the shorter power stroke of prior art engines; at the end of the power stroke the combustion gases are still quite hot (i.e. there is considerable energy still in them) and this is wasted when the combustion gases are forced out of the cylinder by the piston on its exhaust stroke. By giving the engine of the present invention a much longer power stroke (and hence expansion stroke) this heat energy is converted to mechanical energy, as will be explained below.

In prior art engines the objective was to get the maximum amount of air or fuel/air mixture into the cylinder for all settings of the throttle plate. As will be shown below, in the engine of the present invention this is not the case because the compression ratio of the engine of the present invention is considerably above the compression ratio of current engines.

Otto cycle engines have a throttle plate in the intake system; opening and closing this throttle plate regulates the amount of air or fuel/air mixture that enters the cylinders, thereby regulating the speed of the engine. This is the only means of regulating the amount of air that enters the cylinders during the intake stroke of a prior art engine. By contrast, the engine of the present invention has a second means of restricting the amount of air that enters the cylinders in addition to the throttle plate. This second means is the reduced height or modified geometry of the inlet valve cam lobe or any of the means outlined below.

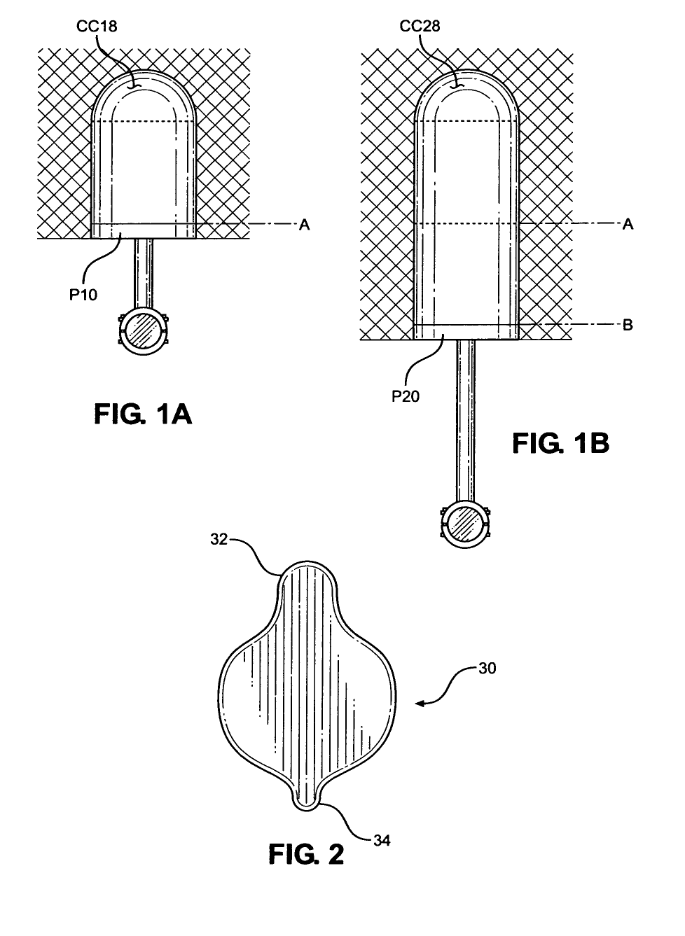

The advantages of the present invention will be evident from FIG. 1. In FIG. 1 pistons P10 and P20 in engines E10 and E20, respectively (not shown), have the same diameter, and the cylinder heads and combustion chambers CC18 and CC28, respectively, are identical except for the intake valve cam lobes, as will be explained. In addition, the carburetors or fuel injector systems are identical. Assume that piston P10 in engine E10 has a stroke length of 5 inches, and piston P20 in engine E20 has a stroke length of 10 inches. Regardless of the compression ratio of engine E10, since pistons P10 and P20 are the same diameter but piston P20's stroke length is twice that of piston P10, the compression ratio of engine E20 is twice that of engine E10. However, the intake valve cam lobe controlling the intake valve of piston P20 (not shown) is modified to reduce the amount of air or fuel/air mixture taken in during piston P20's intake stroke to half that of piston P10.

As a result of this reduction in intake charge into the cylinder of engine E20, when the compression strokes of pistons P10 and P20 are completed the conditions in the combustion chambers of the cylinders of engines E10 and E20 are identical even though their compression ratios are different. That is, even though piston P20 has traveled twice as far as piston P10 in its compression stroke there was only half as much air or fuel/air mixture in the cylinder of engine E20 as in the cylinder of engine E10 at the start of the compression stroke. When this lesser amount of air or fuel/air mixture is compressed twice as much the resulting pressure in the cylinder of engine E20 is the same as in the cylinder of engine E10.

When the spark plugs (not shown) are fired and the fuel/air mixtures are ignited, both pistons are driven down to position A (a distance of 5 inches) with a total force of F. For piston P1 this is bottom dead center, and piston P1 starts to rise up and force the combustion gases out of the exhaust valve (not shown). However, piston P20 has traveled only half of its stroke length; it continues on to position B and then starts to rise up.

Since piston P20 has traveled a greater distance in its power stroke than piston P10, it has extracted more energy from the combustion gases; however, they exert a lesser force on piston P20 during the second half of its travel. Assume that the total force on piston P20 for the second half of its travel is half that of the total force on it for the first half of its travel. Therefore the total force on piston P20 for its entire stroke length is 1.5F.

The torque on the crankshaft of an internal combustion engine is directly proportional to the stroke length of the pistons attached to it; since piston P20 has a stroke length that is twice that of piston P10, the torque on the crankshaft (not shown) exerted by piston P20 will be twice that exerted by piston P10. Since the horsepower generated by an internal combustion engine is directly proportional to the product of the force on the pistons multiplied by the stroke length of the pistons, and since the total force exerted on piston P20 is assumed to be 1.5 times that exerted on piston P10 and the stroke length of piston P20 is twice that of piston P10, it is obvious that in this example engine E20 generates 3 times the horsepower of engine E10 (1.5 times the total force exerted at twice the stroke length). Since conditions in the combustion chambers of engines E10 and E20 at the end of the compression strokes are made identical (by limiting the amount of air or fuel/air mixture inducted into the cylinders of engine E20), the amounts of fuel in cylinders 10 and 20 are identical. Thus engine E20 develops 3 times the horsepower of engine E10 while burning the same amount of fuel.

Obviously the force on piston P20 during the second half of its travel is governed by the amount of energy remaining in the combustion gases at the start of the second half of its travel, the point at which prior art engines begin pumping combustion gases out the exhaust valve. However, that energy is considerable. All engines, when run at high RPMs, waste enough heat energy out of the exhaust valves to cause the exhaust pipes to glow orange. The configuration of the engine of the present invention converts a substantial amount of this heat energy that would otherwise be wasted into mechanical energy in the form of additional force on the piston during its longer stroke.

The primary criterion in the design of a long power stroke engine of the present invention is to see that the pressure in the combustion chamber just prior to ignition is approximately the same as the pressure in a prior art engine for the same application. This pressure can be measured by putting a piezoelectric pressure transducer such as those sold by Piezocryst Advanced Sensors GMBH or PCE Piezotronics in the engine. Substituting this for a spark plug and then cranking the engine with the starter motor (or, if it is a multicylinder engine, running it with such a transducer in one of the cylinders) will allow the peak pressure in the combustion chamber of the prior art engine to be measured, which will establish the corresponding pressure to be obtained in the long power stroke version of that engine. The pressure in the combustion chamber of the long power stroke engine at the conclusion of the compression stroke is determined by varying the amount of air that is inducted during the intake stroke. This in turn can be varied by changing the length of time the intake valve(s) is open, changing the amount that the intake valve(s) is open, changing the diameter of the intake valve(s), by adding a second lobe to the exhaust valve(s) cam lobe so that some air is vented during the compression stroke, or by any other means desired. All of these methods are dependent on the contours of the cam lobes, which will probably require some testing and experimentation to determine.

FIG. 2 shows an exhaust valve cam lobe 30 having conventional exhaust lobe 32 and an additional lobe 34 opposite it for use when fuel is directly injected into the cylinder. This additional lobe 34 is for the purpose of obtaining the proper pressure in the combustion chamber by venting excess air that has been inducted into the cylinder during the intake stroke instead of changing the geometry of the intake valve(s) cam lobe(s).

It will be obvious to those skilled in the art of engine design that the compression ratios, expansion ratios, and stroke lengths shown above are for illustration purposes only; the actual values will vary depending on the application. It will also be obvious to those skilled in the art of engine design that other types of valves can be used to control the flow of air or fuel/air mixture into the cylinder and the flow of exhaust gases out of the cylinder, and that these valves can be operated by other than lobes on a camshaft.

1. An Otto cycle internal combustion engine having a cylinder, intake means for directing air or fuel/air mixture into said cylinder, said means for directing air or fuel/air mixture into said cylinder having a throttle plate therein, an intake valve which opens to allow air or fuel/air mixture into said cylinder on the intake stroke and closes at the end of said intake stroke, a camshaft having a lobe thereon which operates said intake valve, a piston in said cylinder, and a combustion chamber at the top of said cylinder wherein the compression ratio is considerably greater than 13.5:1 but conditions inside the combustion chamber at the conclusion of the compression stroke are approximately the same as those in an engine whose compression ratio is in the range of approximately 6:1 to 13.5:1.

2. An internal combustion engine as in claim 1 having means in addition to said throttle plate for regulating the flow of air into said cylinder.

3. An internal combustion engine as in claim 2 wherein said means in addition to said throttle plate comprises an intake valve camshaft lobe designed to restrict the amount of air allowed into said cylinder during said intake stroke.

4. An internal combustion engine as in claim 3 wherein said intake valve camshaft lobe decreases the amount that the valve is opened compared to prior art intake valve camshaft lobes.

5. An internal combustion engine as in claim 3 wherein said intake valve camshaft lobe decreases the time that the valve is opened compared to prior art intake valve camshaft lobes.

6. An Otto cycle internal combustion engine having a cylinder, exhaust means for conducting combustion gases away from said cylinder, an exhaust valve in said cylinder which opens to allow said combustion gases out of said cylinder and closes at the end of the exhaust stroke, a camshaft having a lobe thereon which operates said exhaust valve, and means for venting air from said cylinder during the compression stroke.

7. An internal combustion engine as in claim 6 wherein said means for venting air from said cylinder during the compression stroke comprises a secondary exhaust valve lobe on said camshaft.

8. The method of increasing the efficiency of an Otto cycle internal combustion engine having a cylinder, a piston in said cylinder, a compression ratio resulting from the travel of said piston in said cylinder, a combustion chamber in said cylinder, a valve for controlling the flow of air or fuel/air mixture into said cylinder, and means for operating said valve, which comprises increasing said compression ratio of said engine to a value in excess of about 13.5:1 and decreasing the amount of air or fuel/air mixture taken into said engine during the intake stroke of said engine such that the conditions in said combustion chamber are the same as before said compression ratio was increased.

9. The method of claim 8 wherein said compression ratio is increased by increasing the stroke of said piston.
